(19) United States
(12) Patent Application Publication
(10) Pub. No.: US 2012/0304915 A1
(43) Pub. Date: Dec. 6, 2012

(54) IMPACT-PROTECTING STRUCTURE

(75) Inventors: SEN-LIN YU, TAIPEI CITY (TW); TSAO-CHANG YU, NEW TAIPEI CITY (TW)

(73) Assignee: HON HAMN ENTERPRISE CO., LTD., NEW TAIPEI CITY (TW)

(21) Appl. No.: 13/152,590

(22) Filed: Jun. 3, 2011

(51) Int. Cl. F21S 10/00

(52) U.S. Cl. 116/202

(57) ABSTRACT

An impact-protecting structure includes a rigid body, a soft body, an adhesive layer, and a plurality of illuminating particles. The rigid body has a corner portion and a plurality of side extending portions extended from the corner portion. The soft body has an impact-resistant portion and a plurality of side covering portions extended from the impact-resistant portion. The soft body covers the outer surface of the rigid body. The adhesive layer is affixed onto the inner surface of the rigid body. The illuminating particles are disposed within the soft body. The impact-protecting structure offers warning capability and buffering effect against impact.

### BACKGROUND OF THE INVENTION

1. Field of the Invention

The instant disclosure relates to an impact protection; more particularly, to an impact-protecting structure having impact warning capability.

2. Description of Related Art

Conventional impact protections can be classified into active and passive types. The active type can provide visual or audio warning. For example, when being approached, the device would illuminate or sound off for warning. The passive type can reduce the damage due to an impact. Some examples are safety pads used on door frames and handrails or corner cushions for furniture. These padded products reduce damages sustained during collisions.

However, the active impact protection must be powered externally or using a battery, besides having higher prices. For the existing devices, many improvements can be made potentially. Therefore, the development of an impact protection having advantages of both active and passive types is the main focus of current research.

### SUMMARY OF THE INVENTION

The instant disclosure is to provide an impact-protecting structure having impact warning capability.

The impact-protecting structure comprises a rigid body, a soft body, an adhesive layer, and a plurality of illuminating particles. The rigid body has a corner portion and a plurality of side extending portions extended from the corner portion. The soft body has an impact-resistant portion and a plurality of covering portions extended from the impact-resistant portion. The soft body covers the outer surface of the rigid body. The adhesive layer is affixed to the inner surface of the rigid body.

Based on the above, the impact-protecting structure of the instant disclosure can glow for warning and buffer against impact. Different types of illuminating particles can be selectively disposed according to the rigid and soft bodies. Based on the combination of rigid and soft bodies, each user can derive different means of using the impact-protecting structure to caution against bumps, scraps, and bruises.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1A is a perspective view for a first embodiment of the instant disclosure.

FIG. 1B is another perspective view for the first embodiment of the instant disclosure.

FIG. 1C is a perspective view showing illuminating particles disposed uniformly throughout a soft body in use for the first embodiment of the instant disclosure.

FIG. 1D is a sectional view of FIG. 1C.

FIG. 1E is a perspective view showing the illuminating particles being confined regionally within the soft body in use for the first embodiment of the instant disclosure.

FIG. 2A is a sectional view showing illuminating particles disposed uniformly throughout a rigid body for a second embodiment of the instant disclosure.

FIG. 2B is a sectional view showing the illuminating particles being confined regionally within the rigid body for the second embodiment of the instant disclosure.

FIG. 3A is a sectional view showing illuminating particles disposed uniformly throughout a rigid body and a soft body for a third embodiment of the instant disclosure.

FIG. 3B is a sectional view showing the illuminating particles being confined regionally within the rigid body and the soft body for the third embodiment of the instant disclosure.

FIG. 4A is a sectional view showing illuminating particles disposed uniformly throughout an adhesive layer for a fourth embodiment of the instant disclosure.

FIG. 4B is a sectional view showing the illuminating particles being confined regionally within the adhesive layer for the fourth embodiment of the instant disclosure.

### DETAILED DESCRIPTION OF PREFERRED EMBODIMENTS

### First Embodiment

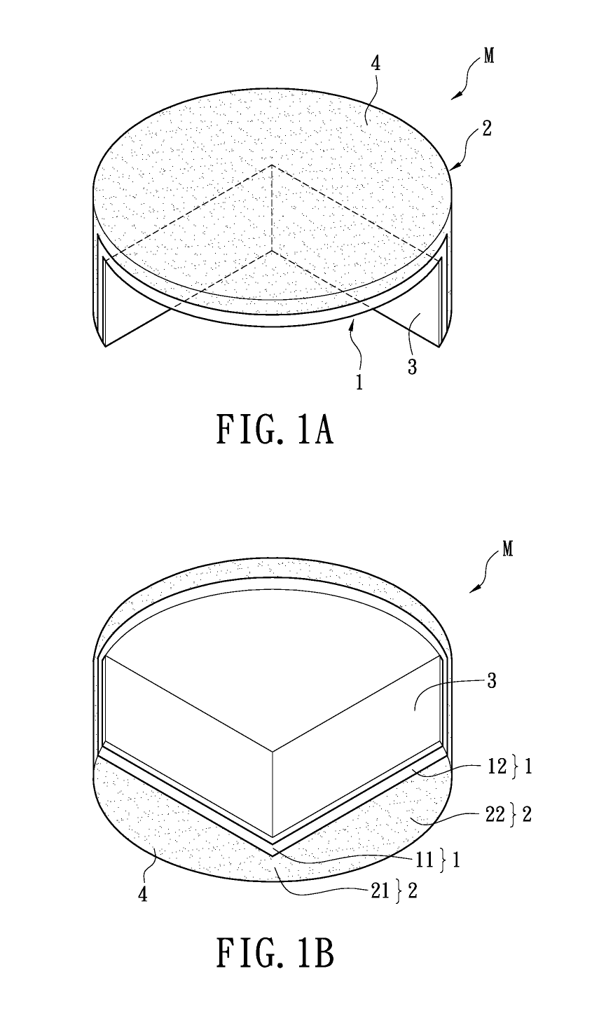

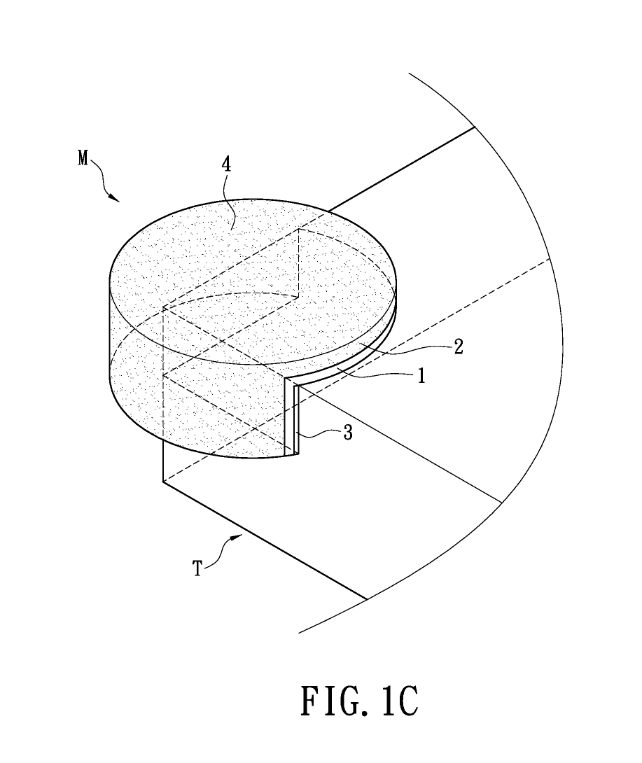

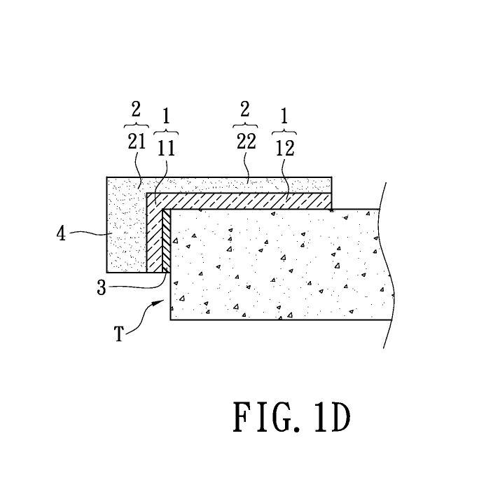

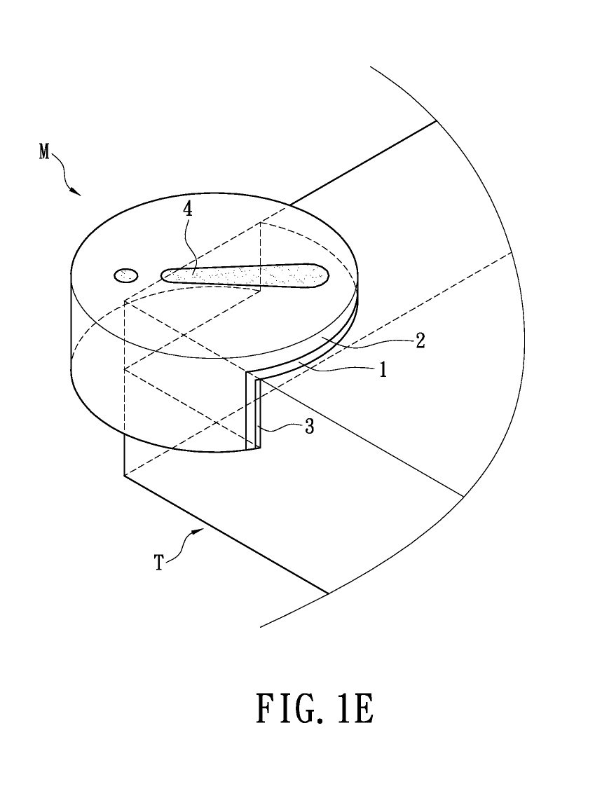

Please refer to FIGS. 1A to 1E, which show an impact-protecting structure M of a first embodiment of the instant disclosure. The impact-protecting structure M comprises a rigid body 1, a soft body 2 (or a resilient body or a flexible body), an adhesive layer 3, and a plurality of illuminating particles 4.

The rigid body 1 can be made of plastic that is impact-resistant, heat-resistant, low temperature-resistant, and chemical-resistant. Other advantages include easy manufacturing, dimensionally stable, good surface luster, excellent light permissivity, and easy color coating. Thereby, the rigid body 1 is suitable as the backbone of the impact-protecting structure M. The rigid body 1 has a corner portion 11 and a plurality of side extending portions 12 extended from the corner portion 11. The corner portion 11 can form a right angle but is not restricted thereto. For example, the corner portion 11 could be rounded as well. The side extending portion 12 is an extension of the corner portion 11. The length of the extension can be varied according to different applications.

The soft body 2 can be made of plastic that is flexible, wear-resistant, tear-resistant, having excellent bending strength, having excellent tensile strength, having a high breaking elongation rate, low-temperature resistant, having low long-term deformation rate, oil-proof, aliphatic solvent-proof, carbon and hydrogen solvent-proof, oxygen and ozone-resistant, anti-aging, and having excellent light permissivity. Thereby, the soft body 2 is suitable for using as a buffering cover for the impact-protecting structure M. The soft body 2 has an impact-resistant portion 21 and a plurality of side covering portions 22 extended from the impact-resistant portion 21. The sizes and shapes of the impact-resistant portion 21 and the covering portions 22 are similar to the corner portion 11 and the side extending portions 12, respectively. The soft body 2 covers the outer surface of the rigid body 1. The impact-resistant portion 21 and the covering portions 22 correspond to the corner portion 11 and the side extending portions 12, respectively.

The adhesive layer 3 is affixed to the inner surface of the rigid body 1. The adhesive layer 3 can use hot glue, double tape, or foam tape. The impact-protecting structure M can be adhered onto a target object through the adhesive layer 3, such as a table T in FIG. 1C.

The illuminating particles 4 can be fluorescent particles or coating fluorescent agents (chemical form is SrMgAl4O8:Eu2+Dy3+). In the figures, the illuminating particles 4 are indicated by dots. When the illuminating particles 4 are disposed internally of the soft body 2, two types of arrangements are available. For the first arrangement, the illuminating particles 4 can be uniformly dispersed throughout the soft body 2 (FIGS. 1A to 1D). Alternatively, the illuminating particles 4 can be confined regionally within the soft body 2, as depicted by the exclamation mark pattern shown in FIG. 1E.

The preceding impact-protecting structure M can use the adhesive layer 3 to affix onto the corner of the table T. When light is shined upon, the fluorescent particles of the illuminating particles 4 of the impact-protecting structure M acts as a visual warning against accidental impact. Alternatively, if the coating fluorescent agents are used, lights can be accumulated while available. When no lights are available, such as at night, the coating fluorescent agents can glow for a few hours to warn and prevent accidental impact. Furthermore, the soft body 2 of the impact-protecting structure M can provide a buffering effect against impact. For example, if the illuminating particles 4 are unable to prevent impact from occurring, the soft body 2 would absorb a portion of the impact energy to minimize the damage. The impact-protecting structure M can be used to enhance household safety, where injury due to accidental bumps, scrapes, and bruises can be prevented. The guard is especially beneficial in preventing injuries from occurring to elders who have poor visions or small children.

Without requiring a power source, the impact-protecting structure of the instant disclosure is equipped with both active warning capability and passive buffering effect. The illuminating particles can be selectively disposed within the soft body uniformly or regionally to give different visual warning patterns. Other warning identifications such as words or symbols are also adoptable without restrictions.

### Second Embodiment

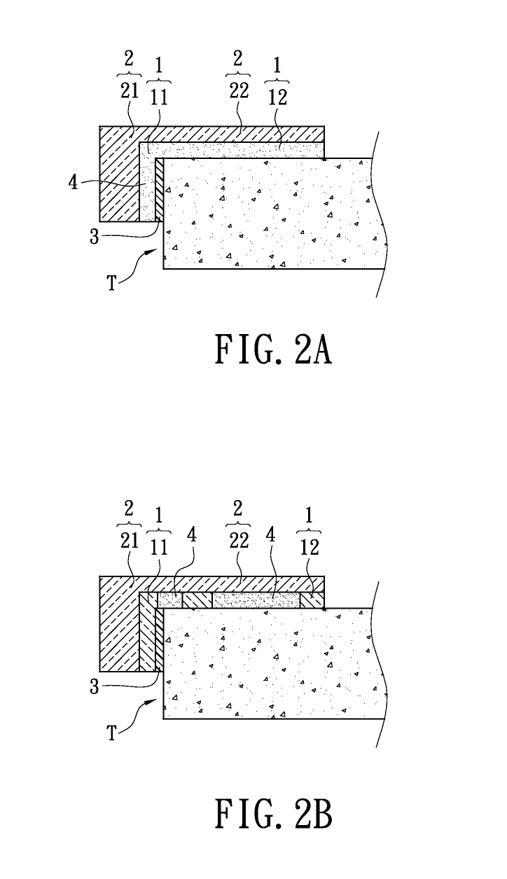

Please refer to FIGS. 2A to 2B. In FIG. 2A, the illuminating particles are dispersed throughout the rigid body internally. However, in FIG. 2B, the illuminating particles are disposed regionally within the rigid body. The main difference between the second and first embodiments is: the illuminating particles 4 of the second embodiment are disposed within the rigid body 1, unlike within the soft body 2 for the first embodiment. All other structural features of the second embodiment are the same as the first embodiment. Therefore, please refer to the first embodiment for the structural descriptions of the rigid body 1, the soft body 2, the adhesive layer 3, and the illuminating particles 4.

Likewise, two different arrangements are available for disposing the illuminating particles 4 within the rigid body 1. The first type is dispersing the illuminating particles 4 uniformly throughout the rigid body 1 as shown in FIG. 2A. The second type is confining the illuminating particles 4 regionally within the rigid body 1, as shown in FIG. 2B. The rigid body 1 having the illuminating particles 4 is covered by the soft body 2. However, the soft body 2 is made of thermoplastic polyurethane (TPU), which is light permissible. Therefore, the warning capability o f the fluorescent particles or coating fluorescent agents remain unaffected.

### Third Embodiment

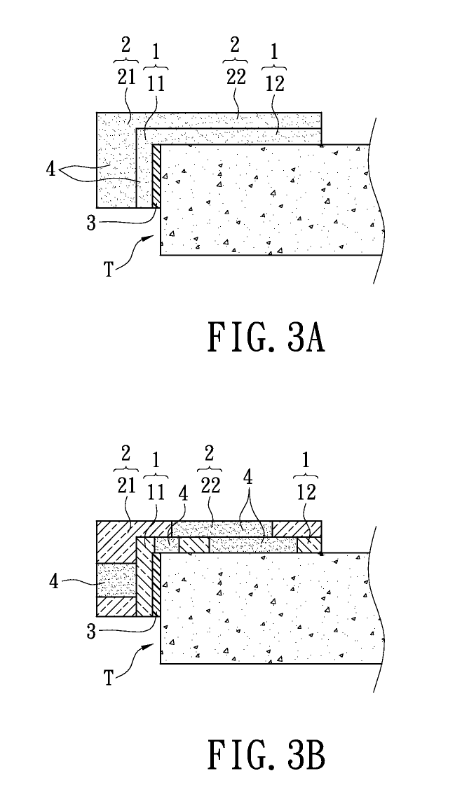

Please refer to FIGS. 3A and 3B. In FIG. 3A, the illuminating particles are dispersed uniformly within the soft and rigid bodies of the impact-protecting structure. In FIG. 3B, the illuminating particles are disposed regionally instead. The third embodiment stands out by having the illuminating particles 4 disposed in both soft and rigid bodies 1 and 2, unlike the first and second embodiments, wherein the illuminating particles 4 are disposed in either soft or rigid body solely. All other structural features of the third embodiment are the same as the first embodiment. Therefore, please refer to the first embodiment for the structural descriptions of the rigid body 1, the soft body 2, the adhesive layer 3, and the illuminating particles 4.

When the illuminating particles 4 are disposed in both rigid and soft bodies 1 and 2, two types of arrangements are available likewise. The first option is to disperse the illuminating particles 4 evenly throughout rigid body 1 and the soft body 2, as indicated by FIG. 3A. The second option is to confine the illuminating particles 4 regionally inside the rigid and soft bodies 1 and 2, as shown by FIG. 3B. Other alternatives include disposing the illuminating particles 4 uniformly throughout the rigid body 1 and regionally in the soft body 2 (not shown), or vice versa (not shown). The above arrangements can be adjusted based on needs accordingly.

The impact-protecting structure of the instant disclosure is simple structurally and easy to manufacture and use. Brief descriptions are given herein for the corresponding manufacturing steps. First, the fluorescent particles and the plastic material are mixed under high temperature, and the mixture is referred as formulation A. The coating florescent agents are mixed with the plastic material, with the mixture being referred as formulation B. Next, a double injection molding machine is employed, wherein formulation A is fed into a mold and hardens to form the rigid body 1. Same process is done for formulation B to obtain the soft body 2. Then, the adhesive layer 3 is affixed on the inner surface of the rigid body 1 to complete the impact-protecting structure M. Based on the preceding procedures, the impact-protecting structure M having the rigid body 1 with fluorescent characteristic and the soft body 2 with light-accumulating capability can be produced. The above steps also allow different combinations of the rigid body 1, the soft body 2, the fluorescent particles, and the coating fluorescent agents to achieve different warning purposes and effects.

### Fourth Embodiment

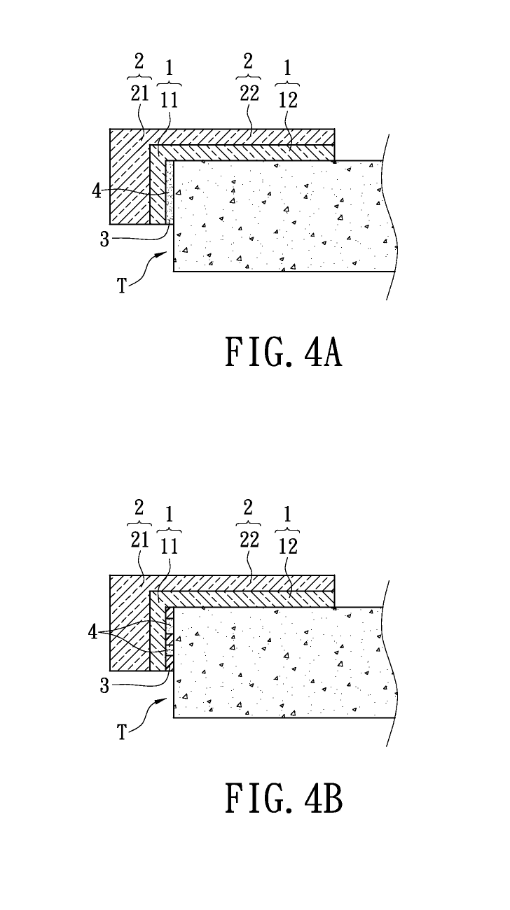

Please refer to FIGS. 4A and 4B. In FIG. 4A, the illuminating particles are dispersed uniformly throughout the adhesive layer. In FIG. 4B, the illuminating particles are confined regionally instead. The fourth embodiment is characterized by having the illuminating particles 4 disposed in the adhesive layer 3, unlike the first and second embodiments wherein the illuminating particles 4 are disposed in either the soft body 2 or the rigid body 1. All other structural features of the fourth embodiment are the same as the first embodiment. Therefore, please refer to the first embodiment for the structural descriptions of the rigid body 1, the soft body 2, the adhesive layer 3, and the illuminating particles 4.

Likewise, the illuminating particles 4 can be disposed in the adhesive layer 3 in two ways. As shown in FIG. 4A, the first option is to disperse the illuminating particles 4 uniformly throughout the adhesive layer 3. The second option is to confine the illuminating particles 4 regionally within the adhesive layer 3 as indicated in FIG. 4B.

If desired, the illuminating particles 4 can coexist in the rigid body 1, the soft body 2, and the adhesive layer 3.

### Advantages

The impact-protecting structure of the instant disclosure provides warning capability and buffering effect against bumps, scrapes, and bruises. The rigid and soft bodies can be opted selectively to include different types of illuminating particles in deriving preferred warning capability.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An impact-protecting structure, comprising:
a rigid body having a corner portion and a plurality of side extending portions extended from the corner;
a soft body having an impact-resistant portion and a plurality of side covering portions extended from the impact-resistant portion, the outer surface of the rigid body being covered by the soft body;
an adhesive layer affixed to the inner surface of the rigid body; and
a plurality of illuminating particles dispersed in the soft body.

2. The impact-protecting structure of claim 1, wherein the illuminating particles are confined regionally within the soft body.

3. The impact-protecting structure of claim 1, wherein the illuminating particles are dispersed uniformly within the soft body.

4. The impact-protecting structure of claim 1, wherein the illuminating particles are fluorescent particles.

5. The impact-protecting structure of claim 1, wherein the illuminating particles are coating fluorescent agents.

6. An impact-protecting structure, comprising:
a rigid body having a corner portion and a plurality of side extending portions extended from the corner portion;
a soft body having an impact-resistant portion and a plurality of side covering portions extended from the impact-resistant portion, the outer surface of the rigid body being covered by the soft body;
an adhesive layer affixed to the inner surface of the rigid body; and
a plurality of illuminating particles dispersed in the rigid body.

7. The impact-protecting structure of claim 6, wherein the illuminating particles are confined regionally within the rigid body.

8. The impact-protecting structure of claim 6, wherein the illuminating particles are dispersed uniformly within the rigid body.

9. The impact-protecting structure of claim 6, wherein the illuminating particles are fluorescent particles.

10. The impact-protecting structure of claim 6, wherein the illuminating particles are coating fluorescent agents.

11. An impact-protecting structure, comprising:
a rigid body having a corner portion and a plurality of side extending portions extended from the corner portion;
a soft body having an impact-resistant portion and a plurality of side covering portions extended from the impact-resistant portion, the outer surface of the rigid body being covered by the soft body;
an adhesive layer affixed to the inner surface of the rigid body; and
a plurality of illuminating particles dispersed in the adhesive layer.

12. The impact-protecting structure of claim 11, wherein the illuminating particles are confined regionally within the adhesive layer.

13. The impact-protecting structure of claim 11, wherein the illuminating particles are dispersed uniformly within the adhesive layer.

14. The impact-protecting structure of claim 11, wherein the illuminating particles are fluorescent particles.

15. The impact-protecting structure of claim 11, wherein the illuminating particles are coating fluorescent agents.
